(19) United States
(12) Patent Application Publication
(10) Pub. No.: US 2013/0006702 A1
(43) Pub. Date: Jan. 3, 2013

(54) SYSTEM FOR COLLECTING AND MANAGING RISK MANAGEMENT FILE AND SAFETY ASSURANCE CASE DATA

(76) Inventor: Fubin Wu, El Dorado Hills, CA (US)

(21) Appl. No.: 13/455,936

(22) Filed: Apr. 25, 2012

Related U.S. Application Data
(60) Provisional application No. 61/479,448, filed on Apr. 27, 2011.

(51) Int. Cl. G06Q 10/06

(52) U.S. Cl. 705/7.28

(57) ABSTRACT

An electronic intermediary electronically connects with a medical device manufacturer and regulatory agencies, collects and processes electronically product life cycle safely related events and information from a medical device manufacturer. The electronic intermediary processes the information collected electronically, integrates, generates, maintains, presents and distributes the risk management file and safely assurance case through the product life cycle using, linking, and connecting the collected and processed data.

### BACKGROUND OF THE INVENTION

The invention relates to a method, an apparatus, and an article of manufacture for electronically developing, generating, integrating, reviewing, maintaining and reporting the risk management file and safety assurance case.

Medical device safety has impact on everyone's life, and is FDA's primary concern. Being able to demonstrate the product safety is essential for the public to be assured on safety and for the medical device manufacturers to succeed as a business entity. Medical device risk management and safely assurance is the central method in managing the safety of the medical devices, and is one of the most complex yet critical quality system disciplines as it involves almost every aspect of the manufacturer operations. Practices and approaches or risk management are widely spread across the industry. Over the decades, the international medical device community has been working on continuously improving the risk management standard. As such, ISO 14971 2007 has been introduced and become recognized by FDA since 2009. Comparing to previous version of the standards. ISO 14971 is a long haul from its previous version. It has been a challenge for the medical device industry to keep up with this state of the art standard, which requires life cycle approach and involves almost every stage and every aspect of the product life cycle: product realization, production, and commercialization. On the other side, over the years, FDA has been encouraging the medical device industry to adapt the assurance ease method to demonstrate safety. In addition, FDA has initiated infusion pump safety improvement initiative, and issued the new guidance on infusion pump in 2010: Total Product Life Cycle: Infusion Pump—Premarket Notification |510(k)| Submissions. The new guidance requires the safety assurance case for product clearance.

### SUMMARY OF THE PROBLEMS TO SOLVE

Medical device manufacturers such as infusion pump manufacturers need comply with international standard on risk management—ISO 14971, which requires maintaining a risk management file for each product, as well as FDA's guidance: Total Product Life Cycle Management—Infusion Pump, which requires Safely Assurance Case for infusion pump 510(k) submission. Currently the medical device manufacturers don't have enough practical methods or tools on
1. How to electronically centralize and maintain the risk management file through the product life cycle
2. How to automatically integrate and synchronize the risk management file and safely assurance case through the product life cycle
3. How to automatically develop and present a safety assurance ease that is readable and maintainable for a complex system such as infusion pump
4. How to electronically submit safety assurance case to FDA
5. How to electronically manage assurance case reviews within FDA

### Summary of what Currently Exists

1. Device manufacturers mostly manually manage the risk management report document in demonstrating the maintenance of the risk management file. This becomes particularly challenging when there are many design or process changes over the product life cycle post product's initial commercialization.
2. The risk management file is spread out across many different places/stages/systems. which can easily lead to incomplete information, broken reference link, not connected or synchronized information, which then could lead to mishandling safely issues that potentially result in safety issues to the patents or the public.
3. Safety assurance ease development required by FDA guidance and risk management activities required by ISO14971 are carried out separately. This creates redundancy and duplication, as well as synchronization issues.
4. The graphic editor tools such as Adelard ASCE Software, Microsoft Visio are the only tools used to develop safety assurance case. This method has challenges for maintenance and connectivity, and can potentially lead to errors that could result in product safety or compliance issues. In addition, assurance case generated graphically using existing method is hard for navigation and review, particularly for a complex system such as infusion pump.
5. Due to the complexity involving multiple areas of expertise, assurance case review by regulatory agencies typically lakes a team effort. It is difficult for regulatory agencies to manage assurance case reviews and ensure consistency without an electronic review management tools.

### SUMMARY OF THE INVENTION

It is an object of the present invention to address many of the challenges associated above. Specifically the objects of the present invention are:
1. Provide a centralized and living mechanism/tool in assuring and demonstrating medical device safely at ongoing basis
2. Improve communications among the medical device manufacturer, medical device user facilities (such as hospitals) and regulatory agencies (e.g. FDA)
3. Improve efficiency and reduce cost for manufacturers, and regulatory reviewers (e.g. FDA)
4. Promote medical device safety

The above objects and advantages of the present invention are achieved by a method, an apparatus, and an article of manufacture for intuitive facilitation of the compiling, review, maintenance, and regulatory submission of the risk management file and safely assurance case. The method comprise: means for connecting electronically an electronic intermediary to a device manufacturer, and regulatory agencies: means for collecting electronically risk management file and safety assurance case data from said device manufacturer; means for electronically processing said data to generate and present safety assurance case: means for electronically centralizing and maintaining the risk management file through the product life cycle: means for integrating of risk management file and safety assurance case through the product life cycle: means for electronically submitting the assurance case electronically to regulatory agencies: means for electronically managing safety assurance case reviews within FDA.

Further, the apparatus of the present invention comprises a general purpose computer programmed with software to operate the general purpose computer in accordance with the present invention. In particular, the apparatus comprises: means for connecting electronically an electronic intermediary to a device manufacturer, and regulatory agencies; means for collecting electronically risk management file and safety assurance case data from said device manufacturer, means for electronically processing said data to generate and present safety assurance case; means for electronically centralizing and maintaining the risk management file through the product life cycle: means for integrating of risk management file and safety assurance case through the product life cycle; means for electronically submitting the assurance case electronically to regulatory agencies; means for electronically managing safety assurance case reviews within regulatory agencies; means for electronically assuring quality system compliance in a real time manner.

Furthermore, the article of manufacture of the present invention comprises a computer-readable medium embodying a computer program. For the present invention, the computer-readable medium embodying the computer program comprises code segments to control a general purpose computer to perform the method of the present invention. Non-limiting examples of a “computer-readable medium” include a magnetic hard disk, a floppy disk, an optical disk, a magnetic tape, a memory chip, and a carrier wave used to carry electronic data, such as those used in transmitting and receiving electronic mail or in accessing an electronic data network, such as the Internet. Further, non-limiting examples of “code segments” include software, instructions, computer programs, or any means for controlling a general purpose computer.

Moreover, the above objects and advantages of the present invention are illustrative, and not exhaustive, of those which can be achieved by the present invention. Thus, these and other objects and advantages of the present invention will be apparent from the description herein or can be learned from practicing the invention, both as embodied herein and as modified in view of any variations which may be apparent to those skilled in the art.

### BRIEF DESCRIPTION OF THE DRAWINGS

FIG. 1 illustrates the relationships of the invention.

FIG. 2 illustrates the procedure of the invention.

FIG. 3 illustrates the example of the table tree format assurance case

FIG. 4 illustrates the example of the graphical format Assurance Case

### DETAILED DESCRIPTION OF THE PREFERRED EMBODIMENTS

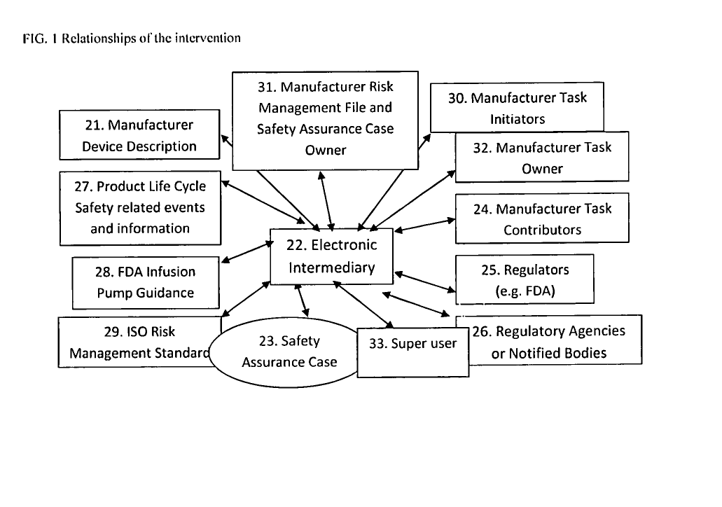

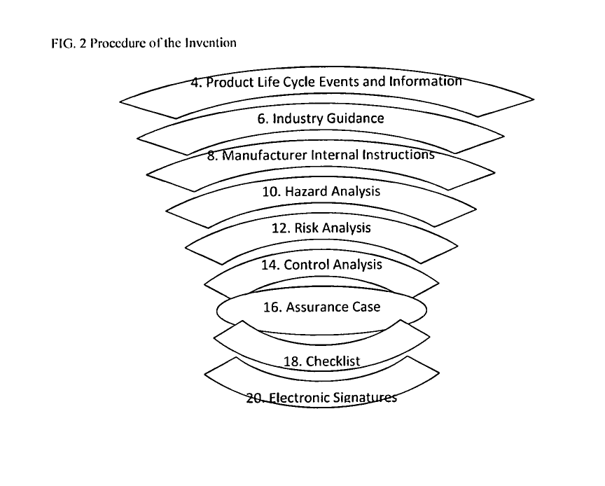

Referring now to the accompanying drawings, wherein similar reference characters refer to similar reference parts throughout the drawings. FIGS. 1, 2 and 3 depict the procedure used in the preferred embodiment for a method, an apparatus, and an article of manufacture for facilitating risk management file and assurance case creation, centralization, review, maintenance, and submission.

Step/Element 4. Product Life Cycle Safely Related Events and Information:

In this step, the Manufacturer task initiator (30) initiates a task triggered by a product life cycle event or information that could result in risk management file and safety assurance case update. The events could happen through the product life cycle including pre-production design and development phase, production manufacturing stage, or post-production on-market stage. Specific examples would include a new or functionality feature, a feature or functionality change, a new design progress, a design change, a process change, an issues found, or a document record that need broad review/approval. The initiator will describe the event and provide the additional information as appropriate including attaching additional documents or files. The manufacturer risk management file and safely assurance case owner will assign the task to an individual (such as a team member) as the task owner (32). The task owner provides the Analysis and Resolutions to address the task assigned including provide task progress updates.

Step/Element 6, Industry Guidance

The electronic intermediary provides a link to a website where is maintained to capture the latest industry guidance associated to risk management and safety assurance ease as related to a particular category of tasks. Examples of the guidance include the latest updated expectations/guidance from FDA, enforcement actions, latest industry standards/guidance, tools, and training/seminars. The frequency of the update can be periodic or as needed.

Step/Element 8, Manufacture Internal Instructions

The electronic intermediary provides the capability for the manufacturer super user to provide the internal instructions to internal users based on the latest SOPs or any relevant quality system update. The electronic intermediary provides the capability for the manufacture regular users to access.

Step/Element 10, Hazard Analysis

In this step, the electronic intermediary will prompt user to review and update as needed the hazard causal tree. The causal tree starts with lop level hazards, then the associated hazard situations, and then deductively break down to next level sub-causes, so on and so forth.

Step/Element 12, Risk Assessment and Evaluation

In the step of the Risk Analysis, The electronic intermediary will allow user to navigate through the hazard causal tree. For each hazard/the user will provide the pre-control and post-control risk assessment results associated to each hazard situations, or corresponding causes/sub-causes. The assessment will include the severity and probability. The electronic intermediary will prompt user to provide any assumptions used for risk assessment. The electronic intermediary will prompt user to provide rationales on the completeness of the sub-causes identified. The electronic intermediary will also prompt user to provide argument for the sufficiency of the controls if there arc direct controls associated to the hazards/causes/sub-causes. The electronic intermediary will prompt user to provide the reference evidence to support the assumptions, completeness rationales, and sufficiency argument as applicable

Step/Element 14, Control Analysis

In the step of the control analysis, the electronic intermediary will prompt user to add applicable controls to mitigate the risks indentified. The electronic intermediary will prompt user to select the controls options, describe the control requirements, and identify objectives in terms of whether it is reducing severity or probabilities. The electronic intermediary will prompt user to provide argument/implementation strategy on how to implement design traceability, validation, and verification. The electronic intermediary will prompt user to provide the design documents/references to demonstrate the control requirements traceability, validation documents to demonstrate the effectiveness of the control requirement, and verification document to demonstrate the correct implementation of the requirements.

Step/Element 16, Assurance Case

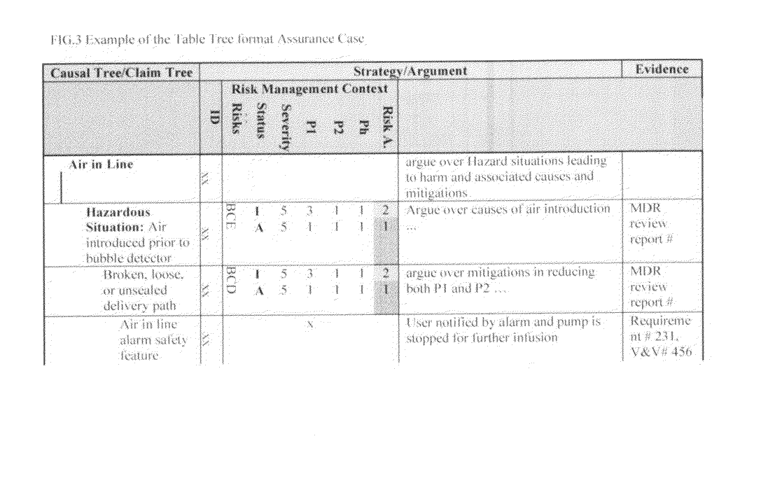

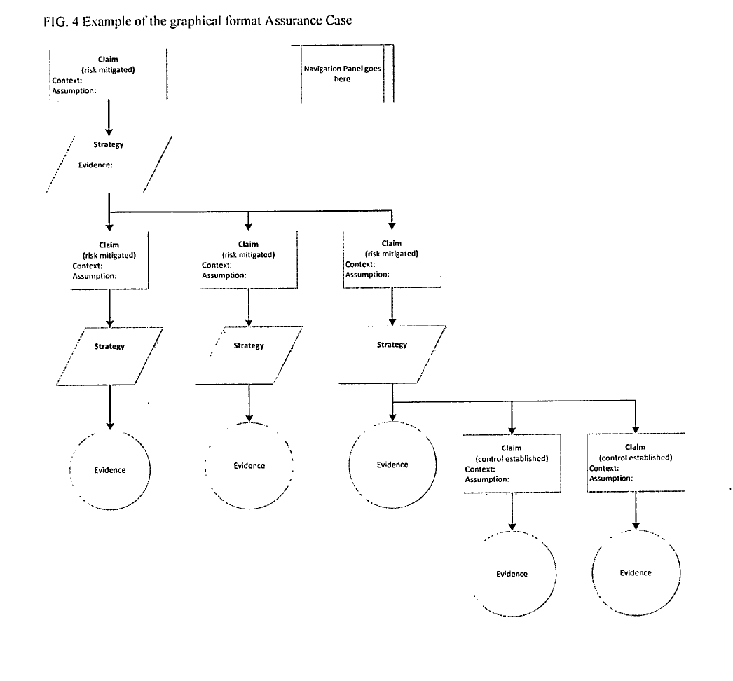

In the step of assurance case, the electronic intermediary will process the data and present in a tree table formal assurance case or graphic format assurance case: The electronic intermediary will automatically convert the hazard causal tree into claims tree. In addition, the electronic intermediary will automatically convert the control requirements as sub-claims for the hazard causal claims the controls are against. As the results, the claim tree will compose of all hazards/causes claiming every element (hazard, cause or sub-causes) have been mitigated to be acceptable, as well as all the claims of the controls have been implemented and effective. It is possible that one hazard/cause have multiple control claims. It is possible that a hazard/cause claim has sub-claims of both sub-cause claims and direct control claims. For each hazard claim, the electronic intermediary will automatically convert the applicable risks and risk assessment and evaluation results pre-control and post-control collected as the claim context for the assurance case hazard claims. For each control claim, the electronic intermediary will automatically convert the risk reduction objective, and the risk control category collected as the claim context for the assurance case control claims. For each hazard claim, the electronic intermediary will automatically convert the risk assessment assumptions, and rationales for the completeness of the sub-claims, and rationales for the effectiveness of the controls as part of the argument/strategy for the assurance case hazard claims. For each control claim, the electronic intermediary will automatically convert the strategy/strategy on the validation of the control effectiveness, the design traceability, and the verification of the correct implementation of the control as part of the argument/strategy for the assurance control claim. For each hazard claim or control claim, the electronic intermediary will automatically convert evidence/reference under the risk analysis or control analysis as the evidence/reference for the assurance ease. The electronic intermediary will present the assurance case a tree table format with following columns: claim tree (on the very left side of the table for easy navigation), risk analysis context, strategy/argument/assumptions. and evidence/reference. Each rows represents a assurance case pattern of what is the claim, what is the context for the claim, what is the strategy/argument for the claim including any assumptions made, and finally what is the corresponding evidence supporting the argument including assumptions. If there are any sub-claims, it will be represented as sub-branches under the claim of the tree. FIG. 3 illustrates the example of the table tree format Assurance Case. The electronic intermediary will also present the assurance case in a graphical format. FIG. 4 illustrates the example of the graphical formal Assurance Case.

8. Checklist

To ensure in rather real time manner that a task is completed in a compliant manner, the electronic intermediary provide a checklist for user to validate all the quality and compliance criteria is met before a task can be closed. Super User will be able to customize the checklist per internal operating procedures as well.

9. Electronic Signatures Review and Approval

Upon completion of all the required elements for a task, the task owner can submit to list of approvers for final review and sign off. The list of the approvers is customized by each manufacturer per internal operation procedures. The approvers will receive an e-mail notice for review/approval. The approvers can choose either approve or reject. The electronic signature information including who, when, which task will be captured lo demonstrate compliance. The electronic signatures are in compliant with FDA regulations CFR 820 Part 11.

What is claimed is:

1. An apparatus for collecting and processing risk management and safely assurance case data comprising: means for connecting electronically an electronic intermediary to a device manufacturer, and regulatory agencies: means for collecting electronically risk management file and safely assurance case data from said device manufacturer: means for processing electronically said data collected from said data providers to generate and present safety assurance case; means for electronically centralizing and maintaining the risk management file through product life cycle; means for integrating of risk management file and safety assurance case through product life cycle: means for electronically submitting the assurance case electronically to FDA. and other regulatory agencies or notified bodies: means for allowing FDA to electronically manage safely assurance case reviews

2. An apparatus as in claim 1, wherein said means for connecting electronically an electronic intermediary to a device manufacture uses an electronic link, and wherein means for collecting electronically risk management and safety assurance data from said data provider uses an electronic link.

3. An apparatus as in claim 2, wherein said electronic link is an electronic data network.

4. An apparatus as in claim 3, wherein said electronic data network is the Internet.

5. An apparatus as in claim 1, wherein said data providers are employers, or contractors of a medical device manufacturer.

6. An apparatus as in claim 1, wherein said risk management file and safety assurance case is defined in ISO 14971 and FDA Infusion Pump Guidance issued in 2010.

7. An apparatus as in claim 1, wherein said a device manufacturer is an infusion pump device manufacturer.

8. An apparatus as in claim 1, wherein said regulatory agencies arc worldwide regulatory agencies such as FDA.

9. An apparatus as in claim 1, wherein said notified bodies are EU notified bodies such as TUV, BSI etc.

10. An apparatus as in claim 1, wherein said product life cycle includes the full life cycle of a medical device from product design and development, manufacturing production, on-market post production until it is obsolete.
REFERENCES
1. ISO 14971 2008 Medical Device Risk Management Process
2. FDA Guidance-Total Life Cycle Management Infusion Pump
3. CMU/SEI/-2009-TN-018: Towards an Assurance Case Practice for Medical Devices
4. Meeting minutes of FDA/AAMI Infusion Pump Summit October 2010
